(19) United States
(12) Patent Application Publication
(10) Pub. No.: US 2005/0011306 A1
(43) Pub. Date: Jan. 20, 2005

(54) Driving system with an automatic transmission

(76) Inventor: Makoto Kirishima, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/621,313

(22) Filed: Jul. 18, 2003

(51) Int. Cl. F16H 59/00

(52) U.S. Cl. 74/661

(57) ABSTRACT

A driving system with an automatic transmission capable of driving a vehicle when an engine is stalled is provided with an electromagnetic clutch 11 between an output shaft 2 of an engine 1 and a ring gear 3 which is engaged by a starter motor 7 for actuating the engine 1. In order to drive a vehicle in an emergency when the engine 1 is stalled, for example, the output shaft 2 of the engine 1 is disconnected from the ring gear 3 by the electromagnetic clutch 11 so that a torque converter 4 and a transmission 5 are separated from the engine 1 and released, and the starter motor 7 is actuated. Thus, the transmission 5 is driven via the ring gear 3 and the torque converter 4 to drive wheels via a drive shaft 6.

### BACKGROUND OF THE INVENTION

The present invention relates to a driving system with an automatic transmission capable of driving a vehicle when an engine is stalled.

FIG. 6 is a schematic view illustrating a conventional driving system with an automatic transmission. In the system shown in FIG. 6, an output shaft 22 of an engine 21 is connected to a torque converter 24 via a ring gear 23. The ring gear 23 is engaged by a starter motor 27 for actuating the engine 21. The output from the engine 21 is transmitted from the output shaft 22 via the torque converter 24 to a transmission 25, and further transmitted through a drive shaft 26 to wheels (not shown).

As described above, in the conventional driving system with an automatic transmission, the output shaft 22 of the engine 21 is constantly connected to the transmission 25 via the torque converter 24. In a vehicle provided with this kind of driving system with an automatic transmission, the starter motor 27 can be actuated only when the shift position is set either in “N (neutral)” or in “P (parking)”. Therefore, the vehicle cannot be driven by the starter motor 27.

On the other hand, a vehicle provided with a driving system with a manual transmission can be driven even when an engine is stopped by trouble for example. Specifically, by setting a predetermined gear position of the transmission and actuating a starter motor with a clutch engaged, wheels are rotated to drive the vehicle. Thus, in an emergency, a vehicle having a manual transmission is driven by driving force of the starter motor to be moved to a safe place.

As described above, it is impossible to drive a vehicle provided with a driving system with an automatic transmission by driving force of the starter motor 27 even in case of emergency. Thus, the conventional system has a disadvantage that the vehicle needs to be pulled and moved by humans or another vehicle in an emergency.

### SUMMARY OF THE INVENTION

An object of the present invention is to provide a driving system with an automatic transmission capable of driving a vehicle when an engine is stalled.

The present invention is a driving system with an automatic transmission in which driving force of an engine is transmitted to wheels via a torque converter and the transmission, which comprises a clutch which connects and disconnects the engine to and from the torque converter and a driving device which actuates the transmission.

According to the present invention, when an engine in a vehicle is stalled, the engine is disconnected from the torque converter with the clutch so that the torque converter and the transmission are released, and the transmission is actuated by the driving device, thereby driving the vehicle. Thus, the vehicle can be driven by a small driving force in case of an engine stall.

Here, the driving device can either indirectly actuate the transmission by driving the torque converter or directly actuate the transmission. By directly actuating the transmission by the driving device, the vehicle can obtain larger driving force.

### BRIEF DESCRIPTION OF THE DRAWINGS

FIG. 1 is a schematic view illustrating a driving system with an automatic transmission according to the first embodiment of the present invention;

FIG. 2 is a schematic view illustrating a driving system with an automatic transmission according to the second embodiment of the present invention;

FIG. 3 is a schematic view illustrating a driving system with an automatic transmission according to the third embodiment of the present invention;

FIG. 4 is a schematic view illustrating a driving system with an automatic transmission according to the fourth embodiment of the present invention;

FIG. 5 is a schematic view illustrating a driving system with an automatic transmission according to the fifth embodiment of the present invention; and

FIG. 6 is a schematic view illustrating a conventional driving system with an automatic transmission.

### DESCRIPTION OF THE PREFERRED EMBODIMENT

(First Embodiment)

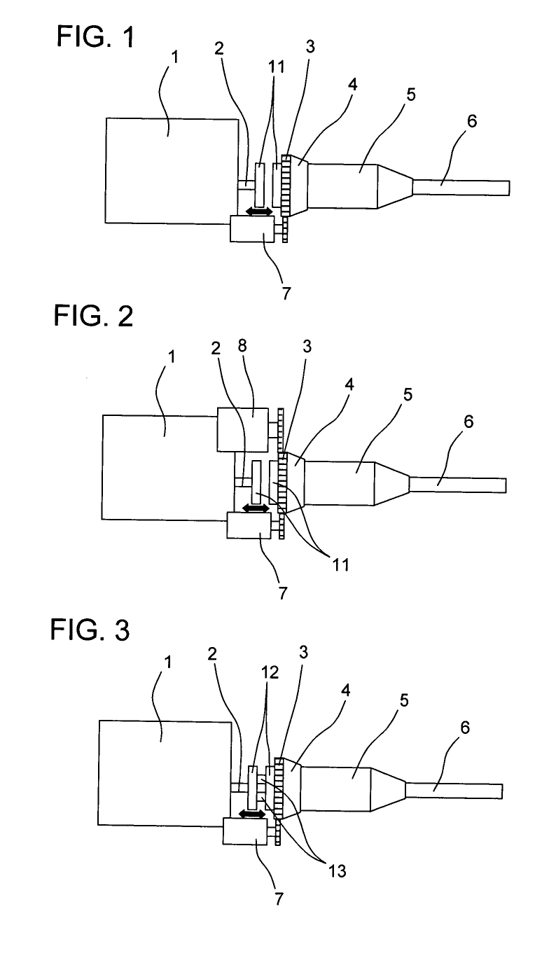

FIG. 1 is a schematic view illustrating a driving system with an automatic transmission according to the first embodiment of the present invention.

As shown in FIG. 1, in a driving system of the first embodiment of the present invention, an electromagnetic clutch 11 is mounted between an output shaft 2 of an engine 1 and a ring gear 3. The ring gear 3 is fixed to a torque converter 4, and the torque converter 4 is connected to a transmission 5. An output shaft of the transmission 5 is connected to a drive shaft 6.

The ring gear 3 is engaged by a starter motor 7 for actuating the engine 1. Normally, by the electromagnetic clutch 11, the output shaft 2 of the engine 1 remains connected to the ring gear 3, whereas, when the engine is stalled, the output shaft 2 is disconnected from the ring gear 3. Thus, to drive a vehicle in ordinary circumstances, the engine 1 is actuated by the ring gear 3 which is driven by the start motor 7.

In the driving system as described above, in order to drive a vehicle in case of emergency, for example, when the engine 1 is stalled, the output shaft 2 of the engine 1 is disconnected from the ring gear 3 by the electromagnetic clutch 11 so that the torque converter 4 and the transmission 5 are separated from the engine 1 and released. Then, by actuating the starter motor 7, the transmission 5 is driven via the ring gear 3 and the torque converter 4, and wheels (not shown) are driven via the drive shaft 6.

As described above, in the driving system of the first embodiment, the engine 1 can be disconnected from the torque converter 4 by the electromagnetic clutch 11. Therefore, in an emergency, the output shaft 2 of the engine 1 is disconnected from the ring gear 3 so that the torque converter 4 and the transmission 5 are separated from the engine 1 and released, thereby driving the vehicle only by small driving force of the starter motor 7.

(Second Embodiment)

FIG. 2 is a schematic view illustrating a driving system with an automatic transmission according to the second embodiment of the present invention.

In the driving system of the second embodiment, an auxiliary motor 8, which engages the ring gear 3, is mounted in addition to the driving system of the first embodiment.

By this structure, when the starter motor 7 alone cannot give sufficient driving force to actuate the transmission 5 via the torque converter 4, the driving force is supplemented by the auxiliary motor 8 to drive a vehicle more smoothly.

(Third Embodiment)

FIG. 3 is a schematic view illustrating a driving system with an automatic transmission according to the third embodiment of the present invention.

In the driving system of the third embodiment of the present invention, a mechanical clutch 12, which can connect and disconnect the output shaft 2 of the engine 1 to and from the ring gear 3 by moving about three or four pins 13 backward and forward, is provided in place of the electromagnetic clutch 11 in the first embodiment. The remaining structure of the third embodiment is the same as the first embodiment.

Also by this structure, the engine 1 can be connected to and disconnected from the torque converter 4 by the mechanical clutch 12 as in the driving system in the first embodiment. Accordingly, in case of emergency, the output shaft 2 of the engine 1 is disconnected from the ring gear 3 so that the torque converter 4 and the transmission 5 are separated from the engine 1 and released, thereby driving a vehicle only by small driving force of the starter motor 7.

(Fourth Embodiment)

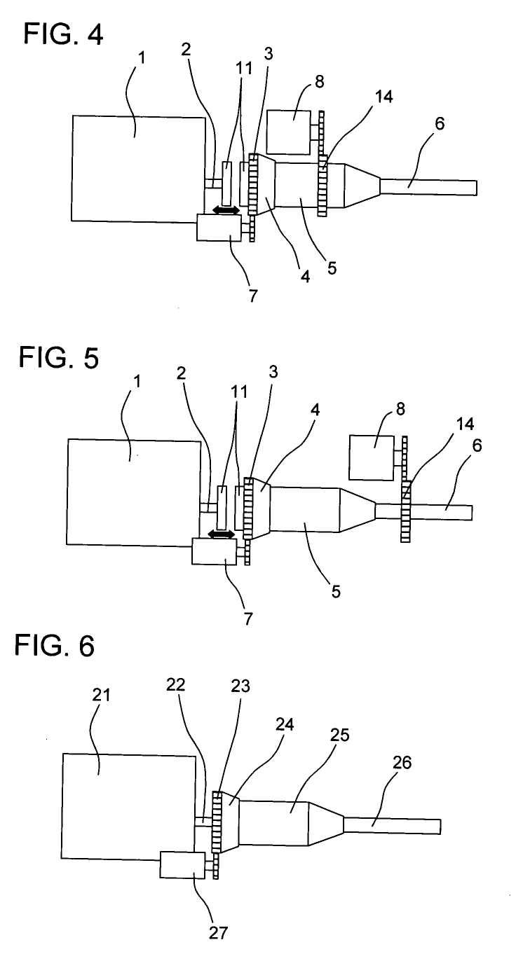

FIG. 4 is a schematic view illustrating a driving system with an automatic transmission according to the fourth embodiment of the present invention.

In the driving system of the fourth embodiment of the present invention, the transmission 5 is provided with a ring gear 14, which is engaged by the auxiliary motor 8. In FIG. 4, each of the members common to the driving system of the first embodiment bears the same reference numeral.

In the driving system with this structure, the output shaft 2 of the engine 1 is disconnected from the ring gear 3 by the electromagnetic clutch 11, and the auxiliary motor 8 is actuated to drive the transmission 5, thereby driving wheels (not shown) via the drive shaft 6. In this case, the wheels are driven by the auxiliary motor 8 without interposing the torque converter 4, which produces greater driving force to drive a vehicle.

(Fifth Embodiment)

FIG. 5 is a schematic view illustrating a driving system with an automatic transmission according to the fifth embodiment of the present invention.

In the driving system of the fifth embodiment of the present invention, the ring gear 14 of the driving system described in the fourth embodiment above is mounted to the drive shaft 6, and the auxiliary motor 8 engages the ring gear 14. The remaining structure of the fifth embodiment is the same as the fourth embodiment.

In the driving system having this structure, the output shaft 2 of the engine 1 is disconnected from the ring gear 3 by the electromagnetic clutch 11, and the auxiliary motor 8 is actuated, thereby driving wheels (not shown) via the drive shaft 6. In this case, the wheels are driven by the auxiliary motor 8 without interposing both the torque converter 4 and the transmission 5, which produces further greater driving force to drive a vehicle.

While particular embodiments of the present invention have been shown and described, numerous variations and alternate embodiments will occur to those skilled in the art. Accordingly, it is intended that the invention be limited only by the appended claims.

1. In a driving system with an automatic transmission in which driving force of an engine is transmitted to wheels via a torque converter and the transmission, the driving system comprising:
a clutch which connects and disconnects the engine to and from the torque converter, and
a driving device which actuates the transmission.

2. The driving system as claimed in claim 1, wherein the driving device actuates the transmission through the torque converter.

3. The driving system as claimed in claim 1, wherein the driving device directly actuates the transmission.
